(19) United States
(12) Patent Application Publication
(10) Pub. No.: US 2007/0149576 A1
(43) Pub. Date: Jun. 28, 2007

(54) Means for protecting against technical materials

(76) Inventors: Thomas Jaetsch, Koln (DE); Rainer Bruns, Leverkusen (DE); Peter Spetmann, Krefeld (DE)

Correspondence Address: LANXESS CORPORATION, 111 RIDC PARK WEST DRIVE, PITTSBURGH, PA, 15275-1112, US

(21) Appl. No.: 10/583,766

(22) PCT Filed: Dec. 15, 2004
(86) PCT No.: PCT/EP04/14287

§ 371 Date: Jun. 21, 2006

(30) Foreign Application Priority Data
Dec. 23, 2003 (DE) 103 60 836.2

(51) Int. Cl. A01N 43/40

(52) U.S. Cl. 514/342

(57) ABSTRACT

The compound of the formula (I) 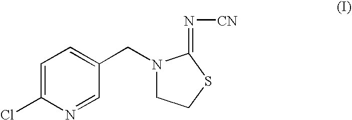 its metal salts or acid addition compounds are highly suitable for protecting industrial materials against attack and/or destruction by insects.

The application relates to the use of the compound 1-(2-chloro-5-pyridylmethyl)-2-cyanoiminothiazolidine (thiacloprid) as a microbicide for protecting industrial materials against attack and destruction by insects. The compound thiacloprid is known from EP-A 235 725, where it is described as being suitable for protecting plants.

The present application provides the use of thiacloprid of the formula (I) 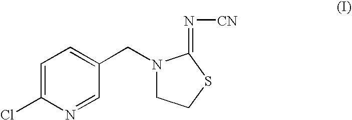
its metal salts or acid addition compounds as microbicide for protecting industrial materials against attack and destruction by insects.

The pyridine derivative may not only be present in the form of the free base but also in the form of a metal salt complex or as acid addition salt. Preferred metal salts are salts of metals of the II. to IV. main group and the I. and II. and the IV. to VII. transition group of the Periodic Table of the Elements, examples which may be mentioned being copper, zinc, manganese, magnesium, tin, iron, calcium, aluminium, lead, chromium, cobalt and nickel.

Suitable anions of the salts are those which are preferably derived from the following acids: hydrohalic acids, such as, for example, hydrochloric acid and hydrobromic acid, furthermore phosphoric acid, nitric acid and sulphuric acid.

The metal salt complexes of the pyridine derivative can be obtained in a simple manner by customary processes, for example by dissolving the metal salt in an alcohol, for example ethanol, and adding it to the thiacloprid. Metal salt complexes can be isolated in a known manner, for example by filtration, and, if appropriate, be purified by recrystallization.

To prepare acid addition salts of the pyridine derivative, preference is given to using the following acids: the hydrohalic acids, such as, for example, hydrochloric acid and hydrobromic acid, in particular hydrochloric acid, furthermore phosphoric acid, nitric acid, sulphuric acid, mono- and bifunctional carboxylic acids and hydroxycarboxylic acids, such as, for example, acetic acid, propionic acid, 2-ethylhexanoic acid, butyric acid, mandelic acid, oxalic acid, succinic acid, 2-hydroxyethanedicarboxylic acid, maleic acid, fumaric acid, tartaric acid, citric acid, salicylic acid, sorbic acid, lactic acid, and also sulphonic acids, such as, for example, p-toluenesulphonic acid, p-decylphenylsulphonic acid, p-dodecylphenylsulphonic acid, 1,4-naphthalenedisulphonic acid, alkanesulphonic acids, benzoic acid and optionally substituted benzoic acids.

The acid addition salts of the compounds can be obtained in a simple manner by customary methods of forming salts, for example by dissolving a compound in a suitable inert solvent and adding the acid, for example hydrochloric acid, and be isolated in a known manner, for example by filtration, and, if appropriate, be purified by washing with an inert organic solvent.

Surprisingly, the compound of the formula (I) has a particularly high insecticidal activity against wood- and plastic-destroying insects, such as, for example,

A: Hymenoptera:
Sirex juvencus
Urocerus augur
Urocerus gigas
Urucerus gigas taignus

B: Beetles:
Anobium punctatum
Apate monachus
Bostrychus capucins
Chlorophores pilosus
Dendrobium pertinex
Dinoderus minutus
Ernobius mollis
Heterobostrychus brunneus
Hylotrupes bajulus
Lyctus africanus
Lyctus Brunneus
Lyctus linearis
Lyctus planicollis
Lyctus pubescens
Minthea rugicollis
Priobium carpini
Ptilinur pecticornis
Sinoxylon spec.
Trogoxylon aequale
Trypto dendron spec.
Xestobium rufovillosum
Xyleborus spec.

C: Termites:
Coptotermes formosanus
Cryptotermes brevis
Heterotermes indicola
Kalotermes flavicollis
Mastotermes darwiniensis
Reticulitermes flavipes
Reticulitermes lucifugus
Reticulitermes santonensis
Zootermopsis nevadensis

The amount of active compound (I) to be employed depends on the nature and the occurrence of the insects and the material to be protected. During application, the optimum amount employed can in each case be determined by test series. However, it is generally sufficient to employ from 0.00005 to 1% by weight, preferably from 0.0005 to 0.1% by weight, of the active compound (I), based on the material to be protected.

The insecticides employed in the protection of wood to date—organophosphorus esters (for example phoxim, chlorpyrifos), synthetic pyrethroids (for example permethrin, cyfluthrin, bifenthrin), IGRs (insect growth inhibitors; for example flufenoxuron, fenoxycarb), nitroimines (for example clothianidin, imidacloprid)—have at least one of the following disadvantages:
a) generally weak activity
b) activity gaps
c) high acute toxicity
d) poor weather persistence, for example against leaching
e) unbalanced activity spectrum

Surprisingly, it has now been found that the active compound of the formula (I), having relatively low acute toxicity, has a particularly high insecticidal activity both against wood-destroying beetles and against wood- and plastic-destroying termites. Furthermore, it has been found, unexpectedly, that, after highly intensive leaching tests according to the European standard test method EN 84, the high activity is not reduced.

The active compound of the formula (I) can be used as such, in the form of concentrates or in the form of generally customary formulations, such as powders, granules, solutions, suspensions, emulsions or pastes.

The formulations mentioned can be prepared in a manner known per se, for example by mixing the active compound of the formula (I) with at least one solvent or diluent, emulsifier, dispersant and/or binder or fixative, water repellent, if appropriate, desiccants and UV stabilizers and, if appropriate, dyes and pigments and other processing auxiliaries.

Suitable solvents or diluents are organochemical solvents or solvent mixtures and/or a polar organic solvent or solvent mixtures and/or an oily or oil-like organochemical solvent or solvent mixture and/or water comprising, if appropriate, an emulsifier and/or wetting agents. Preferred for use as customary water-insoluble oily or oil-like solvents with low volatility are the respective mineral oils/mineral oil-containing solvent mixtures or their aromatic fractions. White spirit, petroleum and alkylbenzenes may be mentioned as being preferred, and additionally spindle oil and monochloronaphthalene. The boiling ranges of these slowly evaporating solvents (solvent mixtures) are in the range of from more than about 170° C. to at most 350° C.

To some extent, the slowly evaporating oily or oil-like solvents described above may be replaced by more volatile organochemical solvents.

To prepare a composition for protecting wood, part of the solvent or solvent mixture described above is preferably replaced by a polar organochemical solvent or solvent mixture. Here, preference is given to using solvents which contain hydroxyl groups, ester groups, ether groups or mixtures of these functionalities. Esters and glycol ethers may be mentioned by way of example. According to the invention, binders are to be understood as being: synthetic resins which can be diluted in water and/or dissolved, dispersed or emulsified in organochemical solvents, binding drying oils, for example those based on acrylate resins, vinyl resins, polyester resins, polyurethane resins, alkyd resins, phenol resins, hydrocarbon resins, silicone resins. The binder used can be employed as a solution, an emulsion or a dispersion. Preference is given to using mixtures of alkyd resins and drying vegetable oil. Particularly preferred are alkyd resins having an oil content between 45 and 70%.

Some or all of the binder mentioned may be replaced by a fixative (mixture) or a plasticizer (mixture). The purpose of these additives is to prevent evaporation of the active compounds and crystallization and/or precipitation. Preferably, they replace from 0.01 to 30% of the binder (based on 100% of the binder employed).

The plasticizers are from the chemical classes of the phthalic esters, such as dibutyl phthalate, dioctyl phthalate or benzyl butyl phthalate, phosphoric esters, such as tributyl phosphate, adipic esters, such as di-(2-ethylhexyl) adipate, stearates, such as butyl stearate and amyl stearate, oleates, such as butyl oleate, glycerol ethers or higher-molecular-weight glycol ethers, glycerol esters and p-toluenesulphonic esters.

Fixatives are based chemically on polyvinyl alkyl ethers such as, for example, polyvinyl methyl ether, or ketones such as benzophenone and ethylenebenzophenone.

A preferred solvent or diluent is water, if appropriate in a mixture with one or more of the abovementioned solvents or diluents, emulsifiers and dispersants. The active compound of the formula (I) or the compositions or concentrates comprising it are preferably employed for protecting wood and timber products and also plastics against attack and destruction by insects, in particular in the protection of tropical wood.

In the context of the present invention, the term “wood” is meant to include solid wood, wood products and wood composites, such as, for example, round timber, cut timber, construction timber, wooden beams, railway sleepers, bridge components, jetties, wooden vehicles, boxes, pallets, containers, telephone poles, wooden fences, wood cladding, windows and doors made of wood, plywood, particle board, joiners' articles, or wood products which, quite generally, are used in the construction of houses or in joinery.

“Plastics” are to be understood as meaning, in particular, polyvinyl chloride (PVC), polystyrene, polyurethane, polyethylene, polypropylene and polyesters. Particularly effective protection of wood can be achieved by employing industrial impregnation processes, for example vacuum, double vacuum or pressure processes.

If appropriate, the active compound of the formula (I) can be employed in combination with at least one other active compound from the group of the insecticides or the fungicides, to widen the activity spectrum or to achieve particular effects, such as, for example, additional protection against wood-destroying fungi. Mixing partners preferred for this purpose are, for example, the following compounds from the group of the fungicides:
sulphenamides, such as dichlofluanid, tolylfluanid, folpet, fluorfolpet;
benzimidazoles, such as carbendazim, benomyl, fuberidazole, thiabendazole or salts thereof;
thiocyanates, such as thiocyanatomethylthiobenzothiazole, methylene bisthiocyanate;
quaternary ammonium compounds and guanidines, such as benzalkonium chloride, benzyldimethyltetradecylammonium chloride,
benzyldimethyldodecylammonium chloride,
dichlorobenzyldimethylalkylammonium chloride, didecyldimethylammonium chloride, dioctyldimethylammonium chloride, N-hexadecyltrimethylammonium chloride, didecylmethylpoly(oxyethyl)ammonium propionate;
morpholine derivatives, such as tridemorph, fenpropimorph, azoles, such as cyproconazole, ipconazole, epoxyconazole, fluquinconazole, triadimefon, triadimenol, bitertanol, tebuconazole, propiconazole, azaconazole, hexaconazole, prochloraz, bromuconazole, metconazole, penconazole, clotimazole, climbazole, imizalil, iodine derivatives, such as diiodomethyl-o-tolylsulphone, 3-iodo-2-propynyl-n-butyl carbamate, 3-iodo-2-propynyl-n-hexyl carbamate, 3-iodo-2-propynylcyclohexyl carbamate, 3-iodo-2-propynylphenyl carbamate, phenol derivatives, such as tribromophenol, tetrachlorophenol, 3-methyl-4-chlorophenol, dichlorophene, o-phenylphenol, 2-benzyl-4-chlorophenol;
isothiazolinones, such as N-methylisothiazolin-3-one, 5-chloro-N-methylisothiazolin-3-one, 4,5-dichloro-N-octylisothiazolin-3-one, N-octylisothiazolin-3-one, benzisothiazolinones, 4,5-trimethylene-N-methylisothiazol-3-one;
methoxyacrylates, such as azoxystrobin, trifloxystrobin;
pyridines, such as 1-hydroxy-2-pyridinthione (and their Na, Fe, Mn, Zn salts), tetrachloro-4-methylsulphonylpyridine;
metal soaps, such as tin naphthenate, copper naphthenate, zinc naphthenate, tin octoate, copper octoate, zinc octoate, tin 2-ethylhexanoate, copper 2-ethylhexanoate, zinc 2-ethylhexanoate, tin oleate, copper oleate, zinc oleate, tin phosphate, copper phosphate, zinc phosphate, tin benzoate, copper benzoate, zinc benzoate;
Metal salts and oxides, such as tributyltin oxide, Cu₂O, CuO, ZnO, CuSO₄, CuCl₂, copper borates, copper fluorosilicates, sodium dichromate, potassium dichromate, copper hydroxycarbonate; tris-N-(cyclohexyldiazeniumdioxy)aluminium, N-(cyclohexyldiazeniumdioxy)tributyltin and potassium salts, bis-N-(cyclohexyldiazeniumdioxy)copper;
dialkyl dithiocarbamates, such as Na and Zn salts of dialkyl dithiocarbamates, tetramethylthiuram disulphide;
nitriles, such as 2,4,5,6-tetrachloroisophthalidinitrile;
benzothiazoles, such as 2-mercaptobenzothiazole;
benzothiophenes, such as bethoxazin;
quinolines, such as quinoxyfen, 8-hydroxyquinoline and their Cu salts;
boron compounds, such as boric acid, boric esters, borax.

Possible insecticides which may be mentioned are;
acetamiprid, allethrin, alpha-cypermethrin, beta-cyfluthrin, bifenthrin, bioallethrin, 4-chloro-2-(2-chloro-2-methylpropyl)-5-[(6-iodo-3-pyridinyl)methoxy]-3(2H)-pyridazinone (CAS-RN: 120955-77-3), chlorfenapyr, chlorpyrifos, clothianidin, cyfluthrin, cyhalothrin, cypermethrin, deltamethrin, ethofenprox, fenoxycarb, fipronil, flufenoxuron, hexaflumuron, imidacloprid, nitenpyram, permethrin, pyriproxifen, silafluofen, tebufenozide, thiamethoxam, tralomethrin, triflumuron.

Preference is given to active compound combinations with the following insecticides:
alpha-cypermethrin, bifenthrin, chlorfenapyr, clothianidin, cyfluthrin, cypermethrin, deltamethrin, fipronil, imidacloprid, permethrin, thiamethoxam.

Particular preference is given to active compound combinations with the following insecticides:
alpha-cypermethrin, bifenthrin, chlorfenapyr, cypermethrin, fipronil, imidacloprid, permethrin, thiamethoxam.

Particularly preferred mixing partners are:
azaconazole, cyproconazole, fluquinconazole, hexaconazole, propiconazole, tebuconazole, triadimenol, triadimefon, imazalil, prochloraz, dichlofluanid, tolylfluanid, thiabendazole, fenpropimorph, tridemorph, bethoxazin, thiocyanatomethylthiobenzothiazole, benzalkonium chloride, didecyldimethylammonium chloride, didecylmethylpoly(oxyethyl)ammonium propionate, 3-iodo-2-propynylbutyl carbamate, trifloxystrobin.

Especially preferred mixing partners are:
cyproconazole, fluquinconazole, tebuconazole, triadimefon, prochloraz, tolylfluanid, bethoxazin, benzalkonium chloride, didecyldimethylammonium chloride, didecylmethylpoly(oxyethyl)ammonium propionate, 3-iodo-2-propynylbutyl carbamate.

The insecticidal compositions or concentrates used according to the invention for protecting industrial materials, in particular wood and plastics, comprise from 0.00001 to 20% by weight, preferably from 0.0001 to 5% by weight, particularly preferably from 0.001 to 1% by weight, of at least one insecticidally active compound, 50 to 100% by weight, preferably 80 to 100% by weight, particularly preferably 90 to 100% by weight and very particularly preferably 98 to 100% by weight of the insecticidally active compound being the active compound of the formula (I).

The compositions according to the invention may comprise at least one further active compound from the group of the abovementioned fungicides in an amount of from 0.01 to 40% by weight, preferably from 0.05 to 25% by weight.

Using the compositions according to the invention, it is possible, in an advantageous manner, to replace the insecticidal compositions available to date by more effective compositions. They have good stability and, in an advantageous manner, a broad activity spectrum.

### EXAMPLES

### Example 1 (Composition for Impregnation)

0.025% of thiacloprid, 0.6% of tebuconazole, 2.67% of alkyd resin, 96.705% of toluene

### Example 2 (Primer)

0.01% of thiacloprid, 0.45% of dichlofluanid, 10% of alkyd resin, 6% of Dowanol DPM, 83.54% of white spirit

### Example 3 (Emulsifiable Concentrate)

0.5% of thiacloprid, 5% of tebuconazole, 35% of Texanol, 32% of emulsifier, 27.5% of cyclohexanone

TABLE 1
Comparative activity thresholds against termites
(EN 117) and wood-destroying beetles (EN 46), tested
according to European standard test methods

| Test insect | thiacloprid | | cyfluthrin | | fenoxycarb |
|---|---|---|---|---|---|
| Reticulitermes santonensis | | | | | |
| (termite) | | | | | |
| EN 117¹⁾ (without stress) | <1 | g/m³ | n.t. | | ineffective |
| EN 117 (with EN 84²⁾ | <1 | g/m³ | 10-20 | g/m³ | against |
| | | | | | termites |
| Hylotrupes bajulus | | | | | |
| (house longhorn beetle) | | | | | |
| EN 46³⁾ (without stress) | <0.01 | g/m² | <0.006 | g/m² | 0.005 g/m² |
| EN 46 (with EN 84) | <0.01 | g/m² | <0.006 | g/m² | 0.050 g/m² |

¹⁾EN 117 Wood preservative; determination of the activity threshold against Reticulitermes santonensis De Feytaud (laboratory test)
²⁾EN 84 Wood preservative; accelerated ageing of treated wood prior to biological testing - leaching stress
³⁾EN 46 Wood preservative; determination of the prophylactic effect on egg larvae of Hylotrupes bajulus (L.) (laboratory test)
⁴⁾EN 73 Wood preservative; accelerated ageing of treated wood prior to biological testing - evaporation stress

1. A method for protecting industrial materials from attack and/or destruction by insects comprising:
applying a composition comprising an insecticidally effective amount of an active compound according to formula (I) 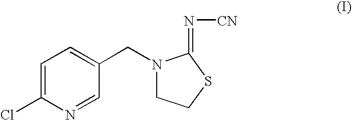
its metal salts, or acid addition compounds to an industrial material for which insecticidal protection is desired.

2. The method according to claim 1, wherein the industrial materials comprise wood, wood composites, timber products and/or plastics.

3. A composition for protecting industrial materials from attack and/or destruction by insects comprising: an insecticidal active compound according to formula (I): 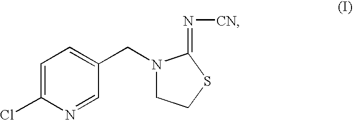
it's metal salts, and/or acid addition compounds thereof and at least one of a solvent and/or a diluent.

4. (canceled)

5. The composition according to claim 3 further comprising an additional compound comprising fungicides and/or insecticides.

6. The composition of claim 3 wherein the insecticidal compound according to formula I is present in the composition in an amount ranging from 50 to 100% by weight based on the weight of the composition.

7.-9. (canceled)

10. The method according to claim 1 wherein formula 1 is applied to the industrial material in an amount such that the industrial material comprises the active compound in an amount ranging from 0.00001 to 20 percent by weight based on the weight of the industrial material to be protected.

11. The method of claim 10 wherein the amount of formula 1 is applied to the industrial material in an amount such that the industrial material comprises the active compound in an amount ranging from 0.0005 to 0.1 percent by weight based on the weight of the industrial material to be protected.

12. The method of claim 1 wherein the amount of formula I present in the composition ranges from 50 to 100 percent by weight based on the total weight of the composition.

13. An industrial material comprising an insecticidal composition comprising an insecticidally active compound according to formula (I): 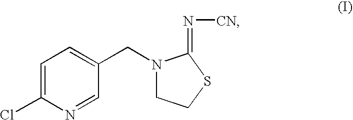
it's metal salts, and/or acid addition compounds.

14. The material of claim 13 wherein the industrial material comprises wood, wood composites, timber products, and/or plastics.

15. The material of claim 13 comprising from 0.00001 to 20 percent by weight of the insecticidally active compound based on the weight of the industrial material.

16. The material of claim 13 wherein the amount of formula I present in the composition ranges from 50 to 100 percent by weight based on the total weight of the composition.

17. The material of claim 13 wherein the composition comprises one or more additional compounds comprising a fungicide and/or an insecticide.

18. The method of claim 1 wherein the composition further comprises additional compounds comprising fungicides and/or insecticides.

19. The method of claim 18 wherein the composition comprises a compound according to formula (I) in an amount ranging from 50 to 100 percent by weight based on the total weight of the composition.

20. The method of claim 1 wherein the composition further comprises a solvent and/or diluent.
